(19) United States
(12) Patent Application Publication
(10) Pub. No.: US 2019/0392390 A1
(43) Pub. Date: Dec. 26, 2019

(54) SYSTEMS AND METHODS FOR ALLOCATING ORDERS IN AN ONLINE ON-DEMAND SERVICE

(71) Applicant: BEIJING DIDI INFINITY TECHNOLOGY AND DEVELOPMENT CO., LTD., Beijing (CN)

(72) Inventor: Zhe XU, Beijing (CN)

(73) Assignee: BEIJING DIDI INFINITY TECHNOLOGY AND DEVELOPMENT CO., LTD., Beijing (CN)

(21) Appl. No.: 16/556,245

(22) Filed: Aug. 30, 2019

Related U.S. Application Data
(63) Continuation of application No. PCT/CN2017/114377, filed on Dec. 4, 2017.

(51) Int. Cl. G06Q 10/08; G06Q 10/04; G06K 9/62; G06Q 50/30

(52) U.S. Cl. CPC G06Q 10/08355; G06Q 50/30; G06K 9/6297; G06Q 10/047

(57) ABSTRACT

Systems and methods for allocating orders in an online on-demand service are provided. A method may include: obtaining a plurality of driver-order pairs, each driver-order pair including an order to be allocated and a driver to be allocated; for each driver-order pair, determining a first matching value based at least partly on the driver and the order in each driver-order pair, obtaining an allocation factor, wherein the allocation factor is associated with a service score of the driver in each driver-order pair, and determining an adjusted matching value based on the first matching value and the allocation factor; identifying a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and allocating each order to the corresponding matching driver.

### CROSS-REFERENCE TO RELATED APPLICATIONS

This application is a continuation of International Application No. PCT/CN2017/114377, filed on Dec. 4, 2017, the contents of which are incorporated herein by reference.

### TECHNICAL FIELD

The present disclosure generally relates to systems and methods for providing an online on-demand service, and in particular, to systems and methods for allocating orders in an online on-demand service.

### BACKGROUND

On-demand transportation services, especially online car hailing services have become more and more popular. When service requesters (e.g., passengers) initiate orders for requesting cars via an online car hailing service platform within a predetermined time period, the server may allocate service providers (e.g., drivers) for the orders, respectively. A problem of the existing technology for allocating orders is that, in some cases, the prior records of the service providers are not taken into consideration when the orders are allocated. For example, the service providers with higher service scores may have lower total incomes after being allocated to orders that, as a whole, generate inferior profit. Accordingly, it is desirable to provide systems and methods for allocating orders based on the service records of the providers (e.g., to increase total incomes of service providers with higher service scores).

### SUMMARY

According to an aspect of the present disclosure, a system may include at least one computer-readable storage medium including a set of instructions for allocating orders in an online on-demand service, and at least one processor in communication with the computer-readable storage medium, wherein when executing the set of instructions, the at least one processor may be directed to: obtain a plurality of driver-order pairs, each driver-order pair including an order to be allocated and a driver to be allocated; for each driver-order pair, determine a first matching value based at least partly on the driver and the order in each driver-order pair, obtain an allocation factor, wherein the allocation factor is associated with a service score of the driver in each driver-order pair, and determine an adjusted matching value based on the first matching value and the allocation factor; identify a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and allocate each order to the corresponding matching driver.

In some embodiments, to obtain a plurality of driver-order pairs, the at least one processor is further directed to obtain a plurality of orders to be allocated within a predetermined time period from a plurality of passenger terminals

In some embodiments, for each driver-order pair, to determine a first matching value based at least partly on the driver and the order in each driver-order pair, the at least one processor is further directed to: determine an order value based on a passenger start location, a destination, and a start time associated with the order; determine a driver cost that the driver will incur driving from a driver start location to the passenger start location; determine an estimated value difference between an estimated value to the driver when the driver is at the driver start location and an estimated value to the driver when the driver is at the destination; and determine the first matching value based on the order value, the driver cost, and the estimated value difference.

In some embodiments, to determine an estimated value difference, the at least one processor is further directed to determine the estimated value difference according to Markov Decision Process (MDP) based on historical business information associated with a plurality of drivers.

In some embodiments, the at least one processor is further directed to: normalize the first matching value.

In some embodiments, the at least one processor determines the driver cost based on at least one of the driver start location, the passenger start location, a vehicle type associated with the driver, and/or traffic conditions.

In some embodiments, to identify a plurality of matched driver-order pairs from the plurality of driver-order pairs, the at least one processor is further directed to: create a bipartite graph including the plurality of driver-order pairs and the adjusted matching values of the plurality of driver-order pairs, wherein an adjusted matching value is an edge weight of a driver-order pair; and identify the plurality of matched driver-order pairs from the plurality of driver-order pairs based on the bipartite graph according to a bipartite graph matching algorithm.

In some embodiments, the bipartite graph matching algorithm includes a Kuhn-Munkres (KM) algorithm.

According to another aspect of the present disclosure, a method for allocating orders in an online on-demand service may be implemented on a computing device having at least one processor, at least one computer-readable storage medium, and a communication platform connected to a network. The method may include one or more following operations: obtaining a plurality of driver-order pairs, each driver-order pair including an order to be allocated and a driver to be allocated; for each driver-order pair, determining a first matching value based at least partly on the driver and the order in each driver-order pair, obtaining an allocation factor, wherein the allocation factor is associated with a service score of the driver in each driver-order pair, and determining an adjusted matching value based on the first matching value and the allocation factor; identifying a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and allocating each order to the corresponding matching driver.

In some embodiments, the obtaining a plurality of driver-order pairs may include obtaining a plurality of orders to be allocated within a predetermined time period from a plurality of passenger terminals.

In some embodiments, for each driver-order pair, the determining a first matching value based at least partly on the driver and the order in each driver-order pair may include one or more following operations: determining an order value based on a passenger start location, a destination, and a start time associated with the order; determining a driver cost that the driver will incur driving from a driver start location to the passenger start location; determining an estimated value difference between an estimated value to the driver when the driver is at the driver start location and an estimated value to the driver when the driver is at the destination; and determining the first matching value based on the order value, the driver cost, and the estimated value difference.

In some embodiments, the determining an estimated value difference may include determining the estimated value difference according to Markov Decision Process (MDP) based on historical business information associated with a plurality of drivers.

In some embodiments, the method may include the following operations: normalizing the first matching value.

In some embodiments, the driver cost is determined based on at least one of the driver start location, the passenger start location, a vehicle type associated with the driver, and/or traffic conditions.

In some embodiments, the identifying a plurality of matched driver-order pairs from the plurality of driver-order pairs may include one or more following operations: creating a bipartite graph including the plurality of driver-order pairs and the adjusted matching values of the plurality of driver-order pairs, wherein an adjusted matching value is an edge weight of a driver-order pair; and identifying the plurality of matched driver-order pairs from the plurality of driver-order pairs based on the bipartite graph according to a bipartite graph matching algorithm.

In some embodiments, the bipartite graph matching algorithm may include a Kuhn-Munkres (KM) algorithm.

According to still another aspect of the present disclosure, a non-transitory computer readable medium, comprising at least one set of instructions for allocating orders in an online on-demand service, wherein when executed by at least one processor of a computer device, the at least one set of instructions directs the at least one processor to: obtain a plurality of driver-order pairs, each driver-order pair including an order to be allocated and a driver to be allocated; for each driver-order pair, determine a first matching value based at least partly on the driver and the order in each driver-order pair, obtain an allocation factor, wherein the allocation factor is associated with a service score of the driver in each driver-order pair, and determine an adjusted matching value based on the first matching value and the allocation factor; identify a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and allocate each order to the corresponding matching driver.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1 is a block diagram of an exemplary system for allocating orders in on online on-demand service according to some embodiments of the present disclosure;

FIG. 2 is a schematic diagram illustrating exemplary hardware and/or software components of a computing device according to some embodiments of the present disclosure;

FIG. 3 is schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process and/or method for allocating orders in an online on-demand service according to some embodiments of the present disclosure;

FIG. 6 is a flowchart illustrating an exemplary process and/or method for obtaining a plurality of driver-order pairs according to some embodiments of the present disclosure;

FIG. 7 is a flowchart illustrating an exemplary process and/or method for determining a first matching value according to some embodiments of the present disclosure;

FIG. 8 is a flowchart illustrating an exemplary process and/or method for determining an estimated value difference according to some embodiments of the present disclosure;

FIG. 9 is a flowchart illustrating an exemplary process and/or method for determining a matching driver for each order according to some embodiments of the present disclosure; and

FIG. 10 is a diagram illustrating an exemplary bipartite graph according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the system and method in the present disclosure is described primarily in regard to online car hailing services, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “driver” in the present disclosure may refer to a combination of information and/or features associated with the driver. The information or features associated with the driver may include a driver identification (e.g., a registration number of the driver), a driver start location, a vehicle type of a vehicle owned by the driver, a vehicle identification (e.g., a plate number of the vehicle), a driver profile (e.g., a service score of the driver), or the like, or any combination thereof. The term “order” in the present disclosure may refer to information associated with an order or features associated with the order. The information or features associated with the order may include an order number, an order start location, an order destination, an order start time, a passenger that initiates the order, an order type, or the like, or any combination thereof.

The position and/or trace in the present disclosure may be acquired by positioning technology embedded in a user terminal (e.g., a passenger terminal, a driver terminal). The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (Wi-Fi) positioning technology, or the like, or any combination thereof. One or more of the above positioning technologies may be used interchangeably in the present disclosure.

An aspect of the present disclosure relates to online systems and methods for allocating orders in an on-demand service. According to the present disclosure, the systems and methods may construct a bipartite graph with a plurality of drivers and orders as vertexes. For each driver-order pair in the bipartite graph, the systems and methods may calculate a matching value based partly on a weight value associated with the service score of each driver. The higher the service score of a driver, the higher the weight value of the driver-order pair. The matching values may be edge weights of the plurality of driver-order pairs in the bipartite graph. The systems and methods may determine an optimum allocating strategy according to calculating a maximum sum weight values of the bipartite graph based on a KM algorithm to allocate each order to corresponding matching driver.

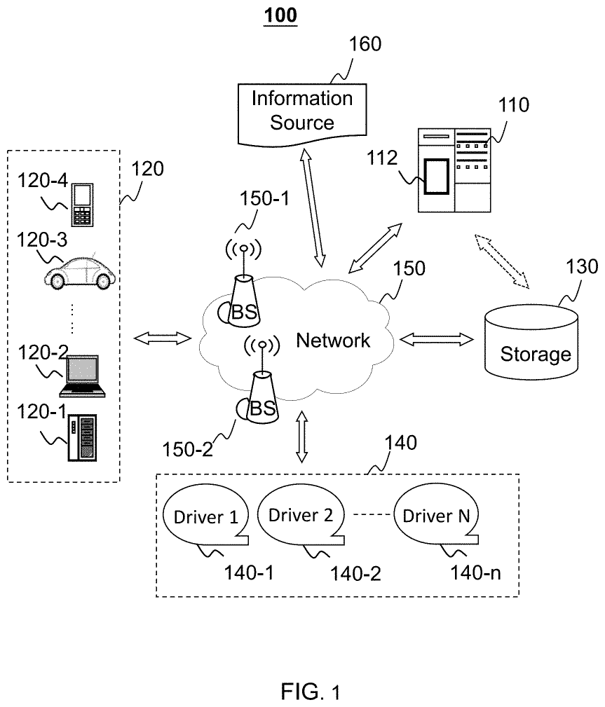

FIG. 1 is a block diagram of an exemplary system 100 for allocating orders in an online on-demand service according to some embodiments of the present disclosure. For example, the system 100 may be an online transportation service platform for transportation services such as car hailing services, chauffeur services, vehicle delivery services, carpooling services, bus services, driver hiring services, and shuttle services, etc. The system 100 may include a server 110, a passenger terminal 120, a storage 130, a driver terminal 140, a network 150 and an information source 160. The server 110 may include a processing engine 112.

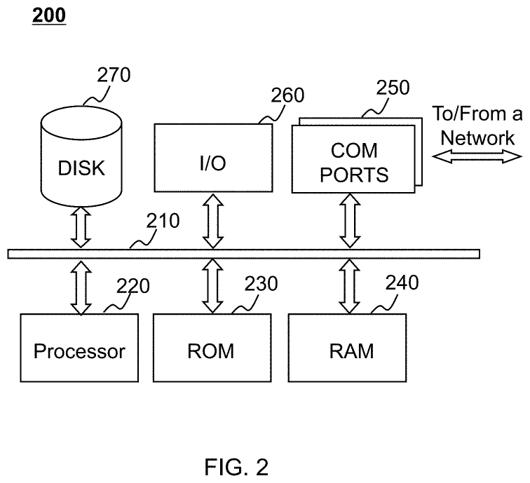

The server 110 may be configured to process information and/or data relating to orders initiated by a plurality of service requesters, for example, orders for hailing cars. For example, the server 110 may receive a plurality of orders from the passenger terminals 120, and process the orders to allocate each order to a corresponding driver terminal 140 according to an allocating strategy. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the passenger terminal 120, the driver terminal 140 and/or the storage 130 via the network 150. As another example, the server 110 may be directly connected to the passenger terminal 120, the driver terminal 140 and/or the storage 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the orders initiated by a plurality of service requesters to perform one or more functions described in the present disclosure. For example, the processing engine 112 may obtain a plurality of orders from the passenger terminals 120, and process the orders to allocate each order to corresponding driver terminal 140 according to an allocating strategy. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the passenger terminal 120 and/or the driver terminal 140 may be an individual, a tool or other entity directly relating to the orders. A passenger may be a service requester. In the present disclosure, “service requester”, “passenger terminal” and “passenger” may be used interchangeably. A driver may be a service provider. In the present disclosure, “driver,” “driver terminal”, and “service provider” may be used interchangeably. In some embodiments, the passenger terminal 120 may include a mobile device 120-1, a tablet computer 120-2, a laptop computer 120-3, and a built-in device 120-4 in a motor vehicle, or the like, or any combination thereof. In some embodiments, the mobile device 120-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, built-in device in the motor vehicle 120-4 may include an onboard computer, an onboard television, etc. In some embodiments, the passenger terminal 120 may be a device with positioning technology for locating the position of the user and/or the passenger terminal 120.

In some embodiments, the driver terminal 140 may be similar to, or the same device as the passenger terminal 120. In some embodiments, the driver terminal 140 may be a device with positioning technology for locating the position of the driver and/or the driver terminal 140. In some embodiments, the passenger terminal 120 and/or the driver terminal 140 may communicate with another positioning device to determine the position of the user, the passenger terminal 120, the driver, and/or the driver terminal 140. In some embodiments, the passenger terminal 120 and/or the driver terminal 140 may transmit positioning information to the server 110.

The storage 130 may store data and/or instructions related to the orders. In some embodiments, the storage 130 may store data obtained/acquired from the passenger terminal 120 and/or the driver terminal 140. In some embodiments, the storage 130 may store data and/or instructions that the server 110 may execute or use to perform exemplary methods described in the present disclosure. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 130 may be connected to the network 150 to communicate with one or more components in the system 100 (e.g., the server 110, the passenger terminal 120, the driver terminal 140). One or more components in the system 100 may access the data or instructions stored in the storage 130 via the network 150. In some embodiments, the storage 130 may be directly connected to or communicate with one or more components in the system 100 (e.g., the server 110, the passenger terminal 120, the driver terminal 140, etc.). In some embodiments, the storage 130 may be part of the server 110.

The network 150 may facilitate exchange of information and/or data. In some embodiments, one or more components in the system 100 (e.g., the server 110, the passenger terminal 120, the storage 130, and the driver terminal 140) may send and/or receive information and/or data to/from other component(s) in the system 100 via the network 150. For example, the server 110 may obtain/acquire orders from the passenger terminals 120 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the system 100 may include one or more network access points. For example, the system 110 may include wired or wireless network access points such as base stations and/or wireless access points 150-1, 150-2, . . . , through which one or more components of the system 100 may be connected to the network 150 to exchange data and/or information.

The information source 160 may be a source configured to provide other information for the system 100. The information source 160 may provide the system 100 with service information, such as weather conditions, traffic information, information of laws and regulations, news events, life information, life guide information, or the like. The information source 160 may be implemented in a single central server, multiple servers connected via a communication link, or multiple personal devices. When the information source 160 is implemented in multiple personal devices, the personal devices can generate content (e.g., as referred to as the “user-generated content”), for example, by uploading text, voice, image and video to a cloud server. An information source may be generated by the multiple personal devices and the cloud server.

FIG. 2 is a schematic diagram illustrating exemplary hardware and software components of a computing device 200 on which the server 110, the passenger terminal 120, the storage 130, the driver 140 and/or the information source 160 may be implemented according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the system 100 as described herein. In FIGS. 1-2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

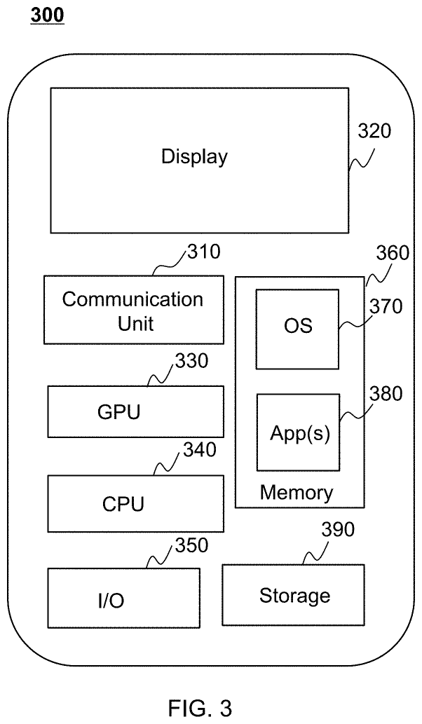

FIG. 3 is a schematic diagram illustrating exemplary hardware and/or software components of an exemplary mobile device 300 on which the passenger terminal 120 or the provider terminal 140 may be implemented according to some embodiments of the present disclosure. As illustrated in FIG. 3, the mobile device 300 may include a communication unit 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, ANDROID™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the location based service providing system on the mobile device 300. User interactions with the information stream may be achieved via the I/O devices 350 and provided to the processing engine 112 and/or other components of the system 100 via the network 120.

In order to implement various modules, units and their functions described above, a computer hardware platform may be used as hardware platforms of one or more elements (e.g., a module of the sever 110 described in FIG. 2). Since these hardware elements, operating systems, and program languages are common, it may be assumed that persons skilled in the art may be familiar with these techniques and they may be able to provide information required in the route planning according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

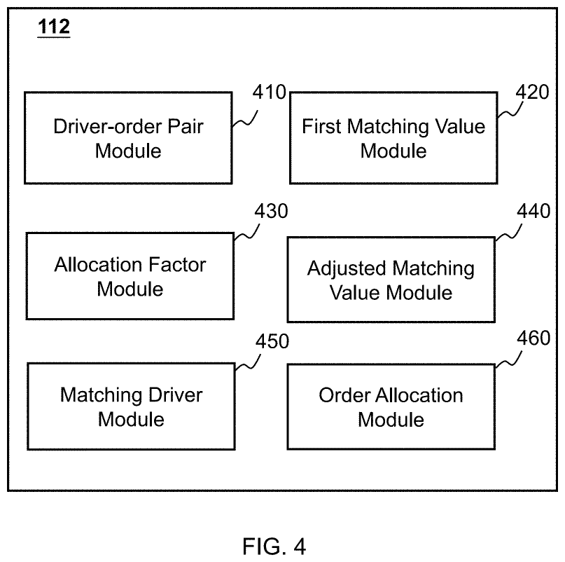

FIG. 4 is a block diagram illustrating an exemplary processing engine 112 according to some embodiments of the present invention. The processing engine 112 may include a driver-order pair module 410, a first matching value module 420, an allocation factor module 430, an adjusted matching value module 440, a matching driver module 450, and an order allocation module 460. Each, part, or all of the modules may be hardware circuits of all or part of the processing engine 112. Each, part, or all of the modules may also be implemented as an application or a set of instructions read and executed by the processing engine. Further, the modules may be any combination of the hardware circuits and the application/instructions. For example, the modules may be the part of the processing engine 112 when the processing engine is executing the application/set of instructions.

The driver-order pair module 410 may be configured to obtain a plurality of driver-order pairs. For example, the driver-order pair module 410 may be configured to obtain one or a plurality of orders to be allocated within the predetermined time period, and one or a plurality of drivers to be allocated based on the plurality of orders. For illustration purposes, the descriptions would refer to “a plurality of orders” and “a plurality of drivers” as examples. It is noted that in some embodiments, only one driver or only one order is obtained. The present invention applies to any embodiments in which multiple order-driver pairs are obtained. In some embodiments, the number of the plurality of the orders is the same as the number of the plurality of the drivers. In some embodiments, the number of the plurality of the orders is different from the number of the plurality of the drivers. The driver-order pair module 410 may also be configured to pair the plurality of orders with the plurality of drivers to obtain the plurality of driver-order pairs.

The first matching value module 420 may be configured to determine a first matching value for a driver-order pair. For example, the first matching value module 420 may be configured to determine a first matching value for each driver-order pair based on the driver, the order, a traffic condition, a weather condition, a special event, or the like, or any combination thereof. As another example, the first matching value module 420 may be configured to determine an order value, a driver cost, an estimated value difference between the estimated value to the driver when the driver is at the driver start location and the estimated value to the driver when the driver is at the destination, or the like, or any combination thereof. As still another example, the first matching value module 420 may be configured to determine an estimated value difference according to MDP.

The allocation factor module 430 may be configured to obtain an allocation factor for each driver-order pair. For example, the allocation factor module 430 may be configured to obtain an allocation factor for each driver-order pair from a storage (e.g., the storage 130, the ROM 230, the RAM 240, etc.) of the system 100. As another example, the allocation factor module 430 may be configured to determine the allocation factor for each driver-order pair based on the service score of the driver.

The adjusted matching value module 440 may be configured to determine an adjusted matching value for each driver-order pair. For example, the adjusted matching value module 440 may be configured to determine the adjusted matching value for each driver-order pair based on the first matching value and the allocation factor associated with each driver-order pair.

The matching driver module 450 may be configured to determine a matching driver for an order from the plurality of driver-order pairs. For example, the matching driver module 450 may be configured to determine a matching driver for each order based on the adjusted matching value for the corresponding driver-order pair. As another example, the matching driver module 450 may be configured to create a bipartite graph including the plurality of driver-order pairs and the adjusted matching values of the plurality of driver-order pairs, and determine a matching driver for each order from the bipartite graph according to a bipartite graph matching algorithm.

The order allocation module 460 may be configured to allocate an order to a matching driver. For example, the order allocation module 460 may be configured to allocate each order to the corresponding matching driver based on the corresponding adjusted matching value. As another example, the order allocation module 460 may be configured to allocate each order to the corresponding matching driver according to a time sequence of the start times associated with the orders.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the first matching value module 420 may be integrated in the adjusted matching value module 440 as a single module that may both determine the first matching value and the adjusted matching value. As another example, the first matching value module 420 may be divided into three units: an order value unit, a driver cost unit, and an estimated value difference unit, which work together to implement the functions of the first matching value module 420, respectively.

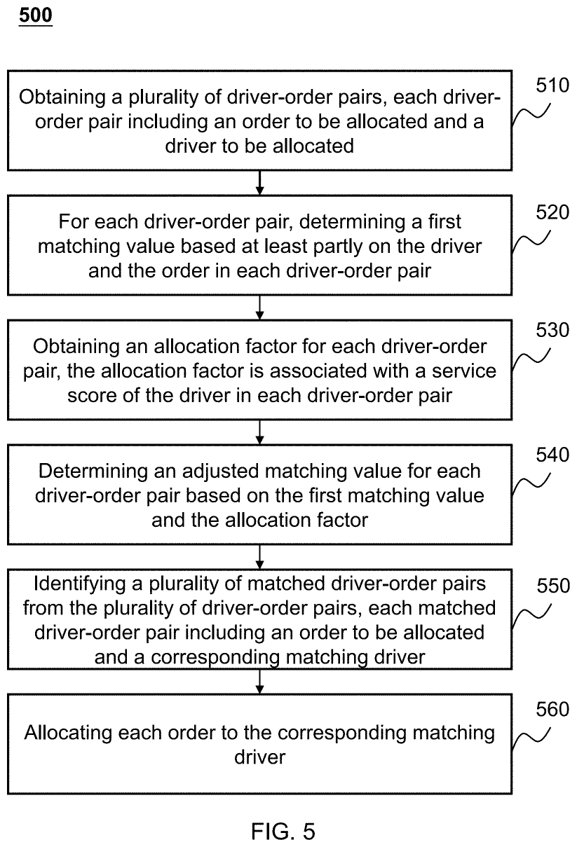

FIG. 5 is a flowchart of an exemplary process and/or method 500 for allocating orders in an online on-demand service according to some embodiments of the present disclosure. In some embodiments, one or more steps in the process 500 may be implemented in the system 100 illustrated in FIG. 1. For example, one or more steps in the process 500 may be stored in the storage (e.g., the storage 130, the ROM 230, the RAM 240, etc.) as a form of instructions, and invoked and/or executed by the server 110 (e.g., the processing engine 112 in the server 110, or the processor 220 of the processing engine 112 in the server 110).

In 510, the processor 220 (or the driver-order pair module 410) may obtain a plurality of driver-order pairs. Each driver-order pair may include an order to be allocated and a driver to be allocated.

In some embodiment, the plurality of orders may be obtained within a predetermined time period from a plurality of passenger terminals 120. In some embodiments, each order may include information or features associated with the order. For example, each order may include a passenger start location, a destination, a start time, an estimated arrival time, an estimated distance of travel, an order time, an order number, an order type, or the like, or any combination thereof.

In some embodiments, the plurality of drivers may be obtained from a large number of drivers that are registered on an online transportation platform based on the plurality of orders. For example, the processor 220 may select the plurality of drivers by choosing the available drivers that are within a predetermined distance, or within a predetermined travel time limit, to at least one of the start locations of the plurality of orders. In some embodiments, the term “driver” may refer to a combination of information or features associated with the driver. For example, each of such combination (i.e., “driver”) may include a driver identification (e.g., a registration number of the driver), a driver start location, a vehicle type of a vehicle owned by the driver, a vehicle identification (e.g., a plate number of the vehicle), a driver profile (e.g., a service score of the driver, a job of the driver, a gender of the driver, etc.), or the like, or any combination thereof.

In some embodiments, the processor 220 may obtain the plurality of driver-order pairs by pairing each order in a plurality of orders to be allocated with each driver in a plurality of drivers to be allocated. For example, if there are 5 drivers associated with an order to be allocated, the order may be paired with each driver of the 5 drivers to generate 5 driver-order pairs. As another example, if there are 5 orders to be allocated and 5 drivers associated with the 5 orders to be allocated, each order of the 5 orders may be paired with each driver of the 5 drivers to generate 25 driver-order pairs.

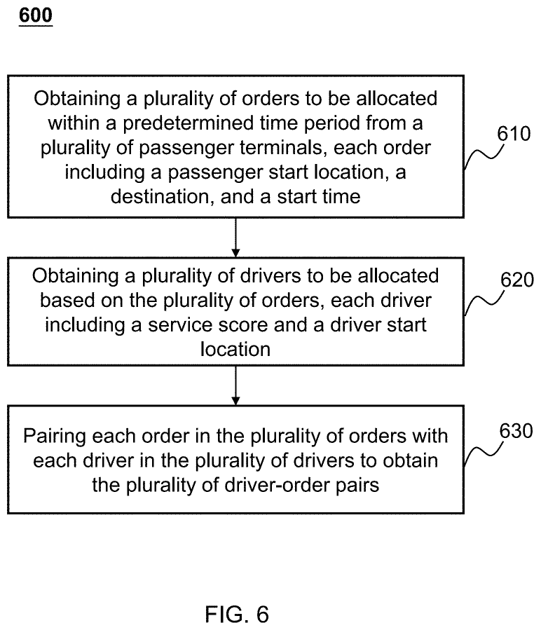

In some embodiments, the obtaining of the plurality of driver-order pair may be found in connection with FIG. 6 and the description thereof in the present disclosure.

In 520, for each driver-order pair, the processor 220 (or the first matching value module 420) may determine a first matching value based at least partly on the driver and the order in each driver-order pair.

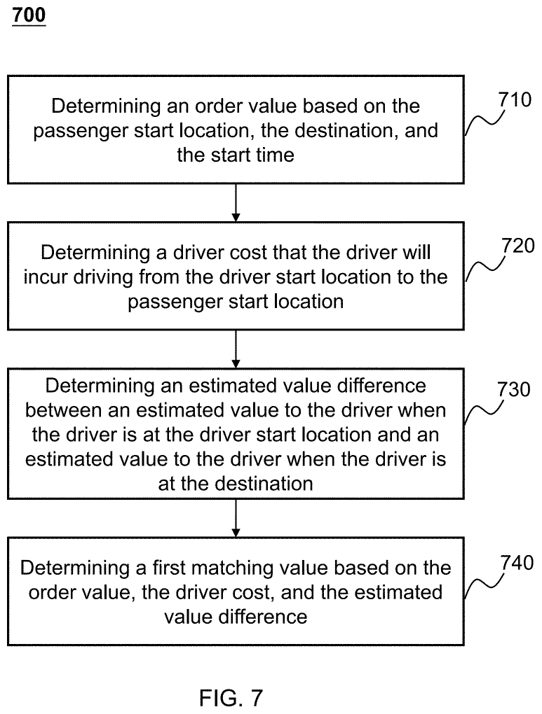

In some embodiments, the first matching value of each driver-order pair may refer to a long-term value that driver may earn after the driver finishes the order. The higher the first matching value is, the higher the total income that driver may earn. In some embodiments, the processor 220 may determine the first matching value based on an order value, a driver cost, an estimated value difference between an estimated value to the driver when the driver is at the driver start location and an estimated value to the driver when the driver is at the destination, or the like, or any combination thereof. In some embodiments, the determination of the first matching value may be found in connection with FIG. 7 and the description thereof in the present disclosure.

In some embodiments, the processor 220 may process the first matching value after determining the first matching value. For example, the processor 220 may normalize the first matching value to obtain a normalized first matching value according to a normalization algorithm (e.g., a Min-Max scaling method, a Z-score standardization, etc.). In some embodiments, the normalized first matching value may be a positive value between 0 and 1. In certain embodiments, the higher the normalized first matching value is, the higher the total income that driver may earn.

In 530, the processor 220 (or the allocation factor module 430) may obtain an allocation factor for each driver-order pair. In some embodiments, the allocation factor may be associated with the service score of the driver in each driver-order pair. In some embodiments, the service score may refer to a quality of service that a driver offers in the system 100. In general, the higher the service score of a driver is, the higher the quality of service that the driver offers. In some embodiments, the service score may be a positive value (e.g., a value between 0 and 1, a value between 0 and 5, a value between 0 and 100, etc.), an alphabetic letter (e.g., a letter from A to Z, a letter from A to F, etc.), or the like, or any combination thereof.

In some embodiments, the allocation factor for each driver-order pair may be predetermined by the system 100, and stored in a storage (e.g., the storage 130, the ROM 230, the RAM 240, etc.) of the system 100. In some embodiments, the processor 220 may determine the allocation factor for each driver-order pair based on the service score of the driver. For example, if a service score of a driver is greater than a score threshold, the processor 220 may determine that the allocation factor of the corresponding driver-order pair is a value greater than 1. If a service score of a driver is lower than the score threshold, the processor 220 may determine that the allocation factor of the corresponding driver-order pair is a positive value lower than 1. In some embodiments, the score threshold may be determined by the system 100 according to different application scenarios.

In 540, the processor 220 (or the adjusted matching value module 440) may determine an adjusted matching value for each driver-order pair based on the first matching value and the allocation factor associated with each driver-order pair.

In some embodiments, the adjusted matching value may refer to a matching probability that a driver in a driver-order pair will be allocated to the corresponding order. The higher the adjusted matching value is, the higher probability that the driver may be allocated to the corresponding order may be. In some embodiments, the processor 220 may determine the adjusted matching value according to equation (1):

v_{new}(d, o)=v(d, o)*q(d) (1)

wherein v_{new}(d, o) denotes an adjusted matching value of a driver-order pair, v(d, o) denotes a first matching value of the driver-order pair, and q(d) denotes an allocation factor of the driver-order pair.

In 550, the processor 220 (or the matching driver module 450) may identify a plurality of matched driver-order pairs from the plurality of driver-order pairs, each matched driver-order pair including an order to be allocated and a corresponding matching driver.

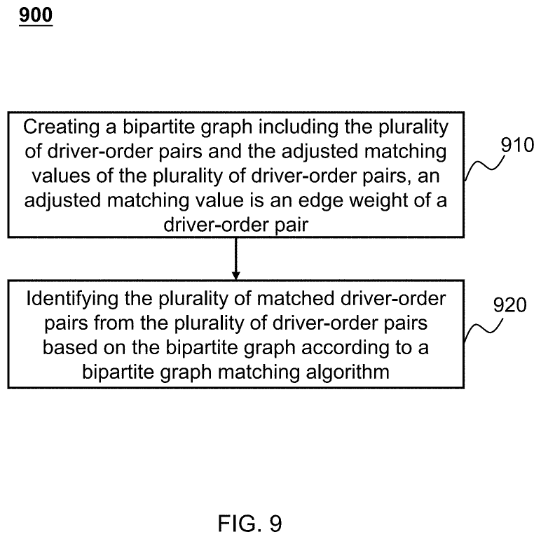

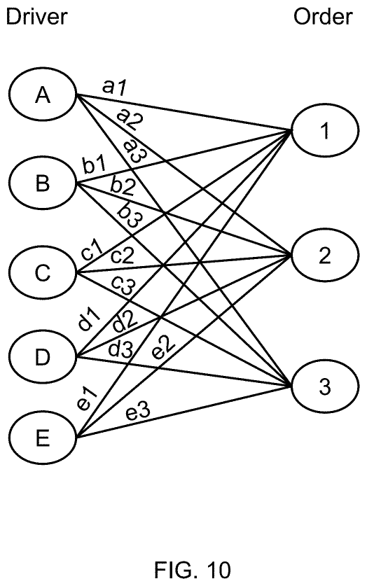

One of the approaches to determine the matching driver is to use a bipartite graph. For example, in some embodiments, the processor 220 may create a bipartite graph. The plurality of orders and drivers may be two vertex sets of the bipartite graph, respectively. Each driver-order pair may refer to an edge of the bipartite graph. The adjusted matching value of each driver-order pair may refer to an edge weight of each edge of the bipartite graph. In some embodiments, the processor 220 may identify the plurality of matched driver-order pairs from the plurality of driver-order pairs based on the bipartite graph. Each of the plurality of matched driver-order pairs includes an order to be allocated and a corresponding matching driver. The plurality of matched driver-order pairs are independent of each other. For the plurality of matched driver-order pairs, a sum of a plurality of adjusted matching values corresponding to the plurality of matched driver-order pairs is maximized. In some embodiments, the processor 220 may determine a matching driver for each order from the plurality of driver-order pairs based on a bipartite graph matching algorithm. For example, the bipartite graph matching algorithm may include a maximum matching algorithm (e.g., a Hungarian algorithm, a Hoperoft-Karp algorithm, etc.), a perfect matching algorithm, an optimal matching algorithm (e.g., a Kuhn-Munkres (KM) algorithm), or the like, or any combination thereof. As another example, the processor 220 may compare the adjusted matching values of the driver-order pairs associated with an order to determine the matching driver for the order. The determined matching driver may be selected from the driver-order pairs associated with the order that has a greatest adjusted matching value among the driver-order pairs. In some embodiments, the determination of the matching driver based on the adjusted matching value for each order may be found in connection with FIG. 9 and FIG. 10, and the description thereof in the present disclosure.

In 560, the processor 220 (or the order allocation module 460) may allocate each order to the corresponding matching driver.

In some embodiments, the processor 220 may allocate the plurality of orders in the plurality of driver-order pairs to the corresponding matching drivers according to a time order of the start time associated with the orders. After being allocated to orders, the matching drivers may drive to the passenger start locations to serve for the passengers associated with the corresponding orders.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 500. As another example, all the steps in the exemplary process/method 500 may be implemented in a computer-readable medium including a set of instructions. The instructions may be transmitted in a form of electronic current or electrical signals.

FIG. 6 is a flowchart of an exemplary process and/or method 600 for obtaining a plurality of driver-order pairs according to some embodiments of the present disclosure. In some embodiments, one or more steps in the process 600 may be implemented in the system 100 illustrated in FIG. 1. For example, one or more steps in the process 600 may be stored in the storage 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 610, the processor 220 (or the driver-order pair module 410) may obtain a plurality of orders to be allocated within a predetermined time period from the plurality of passenger terminals 120. In some embodiments, each order may include information or features associated with the order. For example, each order may include a passenger start location, a destination, a start time, an estimated arrival time, an estimated distance of order, an order time, an order number, an order type, or the like, or any combination thereof.

In some embodiments, a passenger may initiate an order via the passenger terminal 120, and send the order to the server 110 (e.g., the processing engine 112 of the server 110, the processor 220 of the processing engine 112) before being allocated to a driver. In some embodiments, the processor 220 may obtain a plurality of orders to be allocated within a predetermined time period so that the orders can be processed together or in a continuous basis. The predetermined time period may be determined according to different application scenarios. For example, the predetermined time period may be determined based on the area that the passenger start location is in. In certain embodiments, the predetermined time period in an urban area, which may have a higher density for orders and drivers, may be shorter than that in a suburb area. As another example, the predetermine time period may be determined based on the order time (or the passenger start time). In certain embodiments, the predetermined time period in rush hours may be shorter than that in non-rush hours. As still another example, the predetermined time period may be a certain time period predetermined by the system 100, such as 5 seconds, 10 seconds, 30 seconds, 1 minute, 5 minutes, etc.

In some embodiments, the processor 220 (or the driver-order pair module 410) may obtain the plurality of orders to be allocated in a predetermined area within the predetermined time period. The predetermined area may be determined based on the passenger start locations. For example, the processor 220 may divide a city into a number of regions. Each region may be a rectangle or any other regular or irregular shape. In certain embodiments, each region has a same size. In certain embodiments, each region has a similar estimated number of drivers or passengers. In some embodiments, the processor 220 may obtain the plurality of orders to be allocated having passenger start locations in a certain region within the predetermined time period.

In 620, the processor 220 (or the driver-order pair module 410) may obtain a plurality of drivers to be allocated based on the plurality of orders. In some embodiments, the term “driver” may refer to a combination of information or features associated with the driver. For example, each of such combination (i.e., “driver”) may include a driver identification (e.g., a registration number of the driver), a driver start location, a vehicle type of a vehicle owned by the driver, a vehicle identification (e.g., a plate number of the vehicle), a driver profile (e.g., a service score of the driver, a job of the driver, a gender of the driver, etc.), or the like, or any combination thereof.

In some embodiments, the plurality of drivers may be obtained based on the plurality of orders. For example, the plurality of drivers may be selected from a large number of drivers that are registered on an online transportation platform and are available to be allocated to orders based on the passenger start location and the driver start locations. The driver start locations of the plurality of drivers may be within a predetermined distance from the passenger start location. The predetermined distance may be a preset distance value stored in a storage (e.g., the storage 130, the ROM 230, the RAM 240, etc.) of the system 100, or may be determined according to different application scenarios (e.g., the area that the passenger start location locates). As another example, the plurality of drivers may be selected from a large number of drivers that are registered on an online transportation platform and are available to be allocated to orders based on driving durations that the plurality of drivers will take to drive from the driver start locations to the passenger start location. In some embodiments, a driving duration may be determined based a driver start location, a passenger start location, a driving distance from the driver start location to the passenger start location, the traffic condition, the weather condition, or the like, or any combination thereof. In some embodiments, the driving durations of the plurality of drivers may be within a predetermined time period. The predetermined time period may be a preset time value stored in a storage (e.g., the storage 130, the ROM 230, the RAM 240, etc.) of the system 100, or may be determined according to different application scenarios (e.g., the area that the passenger start location locates). As still another example, the plurality of drivers may be selected from a large number of drivers that are registered on an online transportation platform and are available to be allocated to orders based on the region that the passenger start locations are in. The plurality of drivers may be obtained from a region that is within a predetermined distance from the center of the region that the passenger start locations are in.

In 630, the processor 220 (or the driver-order pair module 410) may pair each order in the plurality of orders with each driver in the plurality of drivers to obtain the plurality of driver-order pairs.

In some embodiments, the processor 220 may generate a bipartite graph with the plurality of orders and the plurality of drivers being two vertex sets of the bipartite graph, respectively. Each vertex in the plurality of drivers may connect with each vertex in the plurality of orders to obtain a plurality of edges. Each edge of the bipartite may refer to a driver-order pair.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 600. As another example, all the steps in the exemplary process/method 600 may be implemented in a computer-readable medium including a set of instructions. The instructions may be transmitted in a form of electronic current or electrical signals.

FIG. 7 is a flowchart of an exemplary process and/or method 700 for determining a first matching value for each driver-order pair according to some embodiments of the present disclosure. In some embodiments, one or more steps in the process 700 may be implemented in the system 100 illustrated in FIG. 1. For example, one or more steps in the process 700 may be stored in the storage 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 710, for each order in the plurality of driver-order pairs, the processor 220 (or the first matching value 420) may determine an order value based on the passenger start location, the destination, and the start time.

In some embodiments, the order value may refer to an estimated price that the order may worth. For example, the processor 220 may estimate the order value based on the passenger start location, the destination, the start time, the estimated arrival time, the driving distance of the order, the weather condition, the traffic condition, the demand and supply relationship between the available drivers and the orders, the order type, and/or the like, and/or any combination thereof. As another example, the order value may include a dynamic adjusted price, a travel allowance, a tip from the passenger that initiated the order, or the like, or any combination thereof. In some embodiments, the dynamic adjusted price may be determined by the system 100 according to different application scenarios. For example, if the number of available drivers in the area that the passenger start location is in during a time period (e.g., with a time from the start time) is less than the number of orders that need to be allocated, the processor 220 may determine a dynamic adjusted price, and add the dynamic adjusted price to the order value. In some embodiments, the travel allowance may be determined by the system 100 according to different application scenarios. For example, if the destination of the order is remote from locations that have high service demand (e.g., an urban area or a point of interest such as an airport) or the driver may be forced to empty-drive back from the destination, the processor 220 may determine a travel allowance, and add the travel allowance to the order value based on the likelihood of empty-return and the remoteness of the destination. In certain embodiments, the tip from the passenger may be determined by the passenger. If the passenger pays tip for the order, the processor 220 may add the tip to the order value.

In 720, for each driver-order pair in the plurality of driver-order pairs, the processor 220 (or the first matching value 420) may determine a driver cost that the driver will incur from the driver start location to the passenger start location.

In some embodiments, the driver cost may refer to an estimated cost that the driver may incur if the driver drives from the driver start location to the passenger start location. In some embodiments, the processor 220 may determine the driver cost based on the driver start location, the passenger start location, the order time, the estimated driving distance or duration from the driver start location to the passenger start location, the traffic condition, the weather condition, the vehicle type, and/or any combination thereof.

In 730, for each driver-order pair in the plurality of driver-order pairs, the processor 220 (or the first matching value 420) may determine an estimated value difference between an estimated value to the driver when the driver is at the driver start location and an estimated value to the driver when the driver is at the destination.

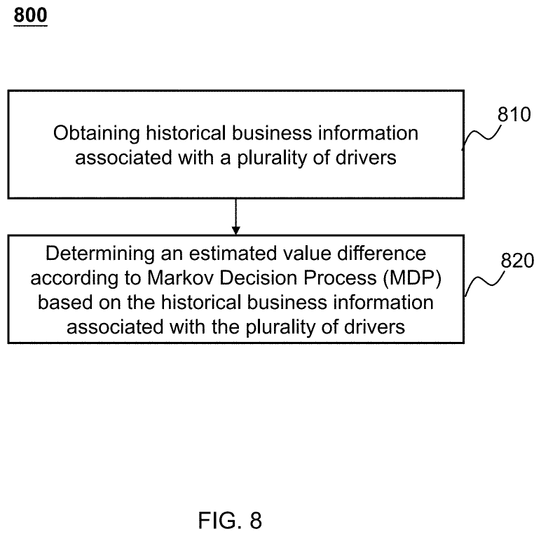

In some embodiments, the estimated value difference may refer to an estimated difference between an estimated value that the driver may earn when the driver is at the driver start location and an estimated value that the driver may earn when the driver is at the destination. For example, if the driver start location is in an area with high service demand (e.g., an urban area), and the destination of the order is in an area with low service demand (e.g., a suburb), the driver may earn more during a subsequent time period (e.g., an hour, several hours, a day, etc.) if the driver stays at the driver start location than at the destination after finishing the order, even if the value of the order itself is taken into consideration. In some embodiments, the processor 220 may determine the estimated value difference according to an algorithm (e.g., Markov Decision Process (MDP)) based on a plurality of historical driver-order pairs. In some embodiments, the determination of the estimated value difference may be further elaborated in connection with FIG. 8 and the description thereof in the present disclosure.

In 740, for each driver-order pair in the plurality of driver-order pairs, the processor 220 (or the first matching value module 420) may determine a first matching value based on the order value, the driver cost, and the estimated value difference.

In some embodiments, the processor may determine the first matching value according to equation (2):

v(d, o)=v(o)−p(d, o)+(v_{d}(finish)−v_{d}(start)) (2)

wherein v(d, o) denotes the first matching value of the driver-order pair, v(o) denotes the order value of the order associated with the driver-order pair, p(d, o) denotes the driver cost of the driver-order pair, v_{d}(finish)−v_{d}(start) denotes the estimated value difference between the estimated value to the driver when the driver is at the driver start location and the estimated value to the driver when the driver is at the destination, v_{d}(finish) denotes the estimated value to the driver when the driver is at the destination, and v_{d}(start) denotes the estimated value to the driver when the driver is at the driver start location.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 700. As another example, all the steps in the exemplary process/method 700 may be implemented in a computer-readable medium including a set of instructions. The instructions may be transmitted in a form of electronic current or electrical signals.

FIG. 8 is a flowchart of an exemplary process and/or method 800 for determining an estimated value difference according to some embodiments of the present disclosure. In some embodiments, one or more steps in the process 800 may be implemented in the system 100 illustrated in FIG. 1. For example, one or more steps in the process 800 may be stored in the storage 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 810, the processor 220 (or the first matching value module 420) may obtain historical business information associated with a plurality historical drivers.

In some embodiments, the plurality of historical drivers may refer to the drivers registered in the online transportation platform, and worked during a certain historical time period (e.g., the last year, the last 3 months, the last month, the last 10 days, etc.). In some embodiments, the historical business information associated with a historical driver may include a plurality of business parameters during a certain historical time period. For example, the historical business information associated with a historical driver may include a plurality of parameters of the historical driver during past 30 days, such as a combination of time-location-status-income. In certain embodiments, the time may refer to a historical point of time or a historical period of time. In certain embodiments, the location may refer to a historical location of the historical driver at the historical point of time or during the historical period of time. In certain embodiments, the status may refer to a working status of the historical driver; for example, the status may include in service status, waiting status for allocating orders, out of service status, etc. In certain embodiments, the income may refer to a current income of the historical driver at the historical point of time or during the historical period of time.

In 820, for each driver-order pair, the processor 220 (or the first matching value module 420) may determine an estimated value difference according to Markov Decision Process (MDP) based on the historical business information associated with the plurality historical drivers.

In some embodiments, the processor 220 may obtain information related to the driver of the driver-order pair when the driver is at the driver start location and designate the obtained information as an input of MDP. For example, the processor 220 may extract at least one feature from the information related to the driver when the driver is at the driver start location. The at least one feature may include a current point of time, the current location that the driver locates (e.g., the driver start location), etc. In some embodiments, the output of MDP may be the estimated value to the driver when the driver is at the driver start location.

In some embodiments, the processor 220 may obtain information related to the driver of the driver-order pair when the driver is at the destination and designate the information as an input of MDP. For example, the processor 220 may extract at least one feature from the information related to the driver when the driver is at the destination of the order. The at least one feature may include the estimated time when the driver arrives at the destination, the destination, etc. In some embodiments, the output of MDP may be the estimated value to the driver when the driver is at the destination.

In some embodiments, the processor 220 may calculate the difference between the estimated value to the driver when the driver is at the driver start location and the estimated value to the driver when the driver is at the destination to obtain the estimated value difference.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 800. As another example, all the steps in the exemplary process/method 800 may be implemented in a computer-readable medium including a set of instructions. The instructions may be transmitted in a form of electronic current or electrical signals.

FIG. 9 is a flowchart of an exemplary process and/or method 900 for determining a matching driver for each order according to some embodiments of the present disclosure. In some embodiments, one or more steps in the process 900 may be implemented in the system 100 illustrated in FIG. 1. For example, one or more steps in the process 900 may be stored in the storage 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 910, the processor 220 (or the matching driver module 450) may create a bipartite graph. The bipartite graph may include the plurality of driver-order pairs and the adjusted matching values of the plurality of driver-order pairs. For example, each driver-order pair may refer to an edge of the bipartite graph, and the corresponding adjusted matching value may refer to the corresponding edge weight of the driver-order pair.

FIG. 10 is a diagram illustrating an exemplary bipartite graph according to some embodiments of the present disclosure. As shown in FIG. 10, the plurality of orders to be allocated may include 3 orders as the right vertex set of the bipartite graph, such as Order 1, Order 2, and Order 3. The plurality of drivers associated with the three orders to be allocated may include 5 orders as the left vertex set of the bipartite graph, such as Driver A, Driver B, Driver C, Driver D, and Driver E. Each driver of the 5 drivers may be paired with each order in the 3 orders to obtain 15 driver-order pairs as 15 edges of the bipartite graph, such as Driver A-Order 1, Driver A-Order 2, Driver A-Order 3, Driver B-Order 1, Driver B-Order 2, Driver B-Order 3, Driver C-Order 1, Driver C-Order 2, Driver C-Order 3, Driver D-Order 1, Driver D-Order 2, Driver D-Order 3, Driver E-Order 1, Driver E-Order 2, and Driver E-Order 3. The adjusted matching values refer to edge weights of the corresponding driver-order pairs (also refers to edges). For example, the adjusted matching values (as edge weights) of the 15 driver-order pairs (as edges) are a1 , a2, a3, b1, b2, b3, c1, c2, c3, d1, d2, d3, e1, e2, and e3, respectively.

In 920, the processor 220 (or the matching driver module 450) may identify the plurality of matched driver-order pairs from the plurality of driver-order pairs based on the bipartite graph according to a bipartite graph matching algorithm.

In some embodiments, the bipartite graph matching algorithm may include a maximum matching algorithm (e.g., a Hungarian algorithm, a Hoperoft-Karp algorithm, etc.), a perfect matching algorithm, an optimal matching algorithm (e.g., a Kuhn-Munkres (KM) algorithm), or the like, or any combination thereof.

For illustration purpose, the matching drivers of the Order 1, Order 2, and Order 3 may be determined based on the KM algorithm. For Order 1, the processor 220 may select a maximum adjusted matching value from a1, b1, c1, d1, and e1; and then for Order 2, the processor 220 may select a maximum adjusted matching value from a2, b2, c2, d2, and e2; and for Order 3, the processor 220 may select a maximum adjusted matching value from a3, b3, c3, d3, and e3. The processor 220 may calculate the sum of the three (3) selected maximum adjusted matching values as a total edge weight of the bipartite graph. In some embodiments, if two or more of the orders have the maximum adjusted matching value corresponding to a same driver, for example, for Order 1 and Order 2, the respective maximum adjusted matching value corresponds to a same driver (e.g., Driver 2), then the processor 220 may select a second maximum adjusted matching value (e.g., a second maximum adjusted matching value of Order 1, and Order 2, respectively) to compare the sums of the selected maximum adjusted matching values. By that analogy, the processor 220 may calculate a plurality of sums of the adjusted matching values of the bipartite graph, each sum of the adjusted matching values includes each order and a unique corresponding driver. The processor 220 may determine a matching driver for each order when the sum of the adjusted matching values of the bipartite graph is maximized. In some embodiments, it should be noted that an order may be allocated to only one driver, and a driver may be allocated to only one order at a same time.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 900. As another example, all the steps in the exemplary process/method 900 may be implemented in a computer-readable medium including a set of instructions. The instructions may be transmitted in a form of electronic current or electrical signals.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for allocating orders in an online on-demand service, comprising:
at least one computer-readable storage medium including a set of instructions for allocating orders in an online on-demand service; and
at least one processor in communication with the computer-readable storage medium, wherein when executing the set of instructions, the at least one processor is directed to:
obtain a plurality of driver-order pairs, each driver-order pair including an order to be allocated and a driver to be allocated;
for each driver-order pair,
determine a first matching value based at least partly on the driver and the order in each driver-order pair,
obtain an allocation factor, wherein the allocation factor is associated with a service score of the driver in each driver-order pair, and
determine an adjusted matching value based on the first matching value and the allocation factor;
identify a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and
allocate each order to the corresponding matching driver.

2. The system of claim 1, wherein to obtain the plurality of driver-order pairs, the at least one processor is further directed to:
obtain a plurality of orders to be allocated within a predetermined time period from a plurality of passenger terminals.

3. The system of claim 1, wherein for each driver-order pair, to determine the first matching value based at least partly on the driver and the order in each driver-order pair, the at least one processor is further directed to:
determine an order value based on a passenger start location, a destination, and a start time associated with the order;
determine a driver cost that the driver will incur driving from a driver start location to the passenger start location;
determine an estimated value difference between an estimated value to the driver when the driver is at the driver start location and an estimated value to the driver when the driver is at the destination; and
determine the first matching value based on the order value, the driver cost, and the estimated value difference.

4. The system of claim 3, wherein to determine the estimated value difference, the at least one processor is further directed to:
determine the estimated value difference according to Markov Decision Process (MDP) based on historical business information associated with a plurality of drivers.

5. The system of claim 1, wherein the at least one processor is further directed to:
normalize the first matching value.

6. The system of claim 3, wherein the at least one processor determines the driver cost based on at least one of the driver start location, the passenger start location, a vehicle type associated with the driver, or traffic conditions.

7. The system of claim 1, wherein to identify the-plurality of matched driver-order pairs from the plurality of driver-order pairs, the at least one processor is further directed to:
create a bipartite graph including the plurality of driver-order pairs and the adjusted matching values of the plurality of driver-order pairs, wherein an adjusted matching value is an edge weight of a driver-order pair; and
identify the plurality of matched driver-order pairs from the plurality of driver-order pairs based on the bipartite graph according to a bipartite graph matching algorithm.

8. The system of claim 7, wherein the bipartite graph matching algorithm includes a Kuhn-Munkres (KM) algorithm.

9. A method for allocating orders in an online on-demand service implemented on a computing device having at least one processor, at least one computer-readable storage medium, and a communication platform connected to a network, comprising:
obtaining a plurality of driver-order pairs, each driver-order pair including an order to be allocated and a driver to be allocated;
for each driver-order pair,
determining a first matching value based at least partly on the driver and the order in each driver-order pair,
obtaining an allocation factor, wherein the allocation factor is associated with a service score of the driver in each driver-order pair, and
determining an adjusted matching value based on the first matching value and the allocation factor;
identifying a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and
allocating each order to the corresponding matching driver.

10. The method of claim 9, wherein the obtaining the plurality of driver-order pairs includes:
obtaining a plurality of orders to be allocated within a predetermined time period from a plurality of passenger terminals

11. The method of claim 9, wherein for each driver-order pair, the determining the first matching value based at least partly on the driver and the order in each driver-order pair includes:
determining an order value based on a passenger start location, a destination, a the start time associated with the order;
determining a driver cost that the driver will incur driving from a driver start location to the passenger start location;
determining an estimated value difference between an estimated value to the driver when the driver is at the driver start location and an estimated value to the driver when the driver is at the destination; and
determining the first matching value based on the order value, the driver cost, and the estimated value difference.

12. The method of claim 11, wherein the determining the estimated value difference includes:
determining the estimated value difference according to Markov Decision Process (MDP) based on historical business information associated with a plurality of drivers.

13. The method of claim 9, further comprising:
normalizing the first matching value.

14. The method of claim 11, wherein the driver cost is determined based on at least one of the driver start location, the passenger start location, a vehicle type associated with the driver, or traffic conditions.

15. The method of claim 9, wherein the identifying the plurality of matched driver-order pairs from the plurality of driver-order pairs includes:
creating a bipartite graph including the plurality of driver-order pairs and the adjusted matching values of the plurality of driver-order pairs, wherein an adjusted matching value is an edge weight of a driver-order pair; and
identifying the plurality of matched driver-order pairs from the plurality of driver-order pairs based on the bipartite graph according to a bipartite graph matching algorithm.

16. The method of claim 15, wherein the bipartite graph matching algorithm includes a Kuhn-Munkres (KM) algorithm.

17. A non-transitory computer readable medium, comprising at least one set of instructions for allocating orders in an online on-demand service, wherein when executed by at least one processor of a computer device, the at least one set of instructions directs the at least one processor to:
obtain a plurality of driver-order pairs, each driver-order pair including an order to be allocated and a driver to be allocated;
for each driver-order pair,
determine a first matching value based at least partly on the driver and the order in each driver-order pair,
obtain an allocation factor, wherein the allocation factor is associated with a service score of the driver in each driver-order pair, and
determine an adjusted matching value based on the first matching value and the allocation factor;
identify a plurality of matched driver-order pairs from the plurality of driver-order pairs, each matched driver-order pair including an order to be allocated and a corresponding matching driver, wherein the plurality of matched driver-order pairs are independent of each other and a sum of a plurality of adjusted matching values corresponding to the plurality of matched driver-order pairs is maximized; and
allocate each order to the corresponding matching driver.

18. The non-transitory computer readable medium of claim 17, wherein to obtain the plurality of driver-order pairs, the at least one set of instructions further directs the at least one processor to:
obtain a plurality of orders to be allocated within a predetermined time period from a plurality of passenger terminals

19. The non-transitory computer readable medium of claim 17, wherein for each driver-order pair, to determine the first matching value based at least partly on the driver and the order in each driver-order pair, the at least one set of instructions further directs the at least one processor to:
determine an order value based on a passenger start location, a destination, and a start time associated with the order;
determine a driver cost that the driver will incur driving from a driver start location to the passenger start location;
determine an estimated value difference between an estimated value to the driver when the driver is at the driver start location and an estimated value to the driver when the driver is at the destination; and
determine the first matching value based on the order value, the driver cost, and the estimated value difference.

20. The non-transitory computer readable medium of claim 18, wherein to identify the plurality of matched driver-order pairs from the plurality of driver-order pair, the at least one set of instructions further directs the at least one processor to:
create a bipartite graph including the plurality of driver-order pairs and the adjusted matching values of the plurality of driver-order pairs, wherein an adjusted matching value is an edge weight of a driver-order pair; and
identify the plurality of matched driver-order pairs from the plurality of driver-order pairs based on the bipartite graph according to a bipartite graph matching algorithm.
